(19) United States
(12) Patent Application Publication
(10) Pub. No.: US 2025/0037956 A1
(43) Pub. Date: Jan. 30, 2025

(54) FUSE BODY FOR FUSE AND FUSE

(71) Applicant: Cooper Xi'An Fusegear Co., Ltd., Xi-An (CN)

(72) Inventors: Lei Zhang, Xi An (CN); Huasheng Wang, Xi An (CN); Gangpeng Fan, Xi An (CN)

(21) Appl. No.: 18/782,448

(22) Filed: Jul. 24, 2024

(30) Foreign Application Priority Data
Jul. 26, 2023 (CN) 202321985743X
Jul. 26, 2023 (CN) 2023109244585

(51) Int. Cl. H01H 85/08; H01H 85/38

(52) U.S. Cl. CPC H01H 85/08; H01H 85/38

(57) ABSTRACT

This disclosure relates to fuse body for the fuse and the fuse. The fuse body has a longitudinal direction along a length direction and a transverse direction along a width direction, wherein the fuse body comprises: a main body; a first fusing section comprising a first set of through holes arranged in the main body along the transverse direction and a first set of narrow paths formed in the main body along the orientation of the first set of through holes, wherein along the longitudinal direction, the area of the cross-section of each narrow path of the first set of narrow paths is constant; a second fusing section spaced apart from the first fusing section along the longitudinal direction, wherein the second fusing section comprises a second set of through holes disposed in the main body along the transverse direction and a second set of narrow paths formed in the main body along the orientation of the second set of through holes, wherein along the longitudinal direction, the area of the cross-sectional of each narrow path of the second set of narrow paths tapers in a direction toward the center of this narrow path; wherein a transverse spacing between two adjacent narrow paths of the first set of narrow paths is less than a transverse spacing between two adjacent narrow paths of the second set of narrow paths.

### CROSS REFERENCE TO RELATED APPLICATIONS

This application claims priority to Chinese Patent Application Nos. 2023109244585 and 202321985743X, both filed on Jul. 23, 2023, the content of which is hereby incorporated herein in their entireties.

### TECHNICAL FIELD

This disclosure relates to the technical field of short-circuit and overload protection of electric circuits, and in particular relates to fuse body for fuse and fuse.

### BACKGROUND

A fuse is a circuit protection device that disconnects a circuit by fusing the fuse body with its own heat within a certain time frame when the current exceeds a specified value. Currently, fuse is widely used in the field of electric vehicles. In the early stage of the development of electric vehicles, the requirements for the power distribution system are: large opening capacity, miniaturization, and fast fusing. For this reason, AR fast fuses are generally selected for power distribution system protection. With the gradual standardization of the electric vehicle industry, more and higher requirements have been put forward for fuses used in distribution system protection to meet the protection needs of different loads under a variety of operating conditions. For example, there is now a demand for fuse that, in addition to the characteristics of the original AR-type fuse, should also have 1.1 In (1.1 times the rated current) overload withstand, 2 In, 3 In and 5 In overload and short-circuit protection capabilities at the same time.

### SUMMARY OF THE INVENTION

This disclosure is intended to provide a fuse body for a fuse that solves at least some of the above technical problems.

This disclosure is also intended to provide a fuse that applies the improved fuse body described above.

According to an aspect of this disclosure, there is provided a fuse body for a fuse having a longitudinal direction along a length direction and a transverse direction along a width direction, wherein the fuse body comprises: a main body; a first fusing section comprising a first set of through holes arranged in the main body along the transverse direction and a first set of narrow paths formed in the main body along the orientation of the first set of through holes, wherein in the longitudinal direction, the area of the cross-section of each narrow path of the first set of narrow paths is constant; a second fusing section spaced apart from the first fusing section in the longitudinal direction, wherein the second fusing section comprises a second set of through holes disposed in the main body along the transverse direction and a second set of narrow paths formed in the main body along the orientation of the second set of through holes, wherein in the longitudinal direction, the area of the cross-sectional of each narrow path of the second set of narrow paths tapers in a direction toward the center of this narrow path; wherein a transverse spacing between two adjacent narrow paths of 2023109244585 the first set of narrow paths is less than a transverse spacing between two adjacent narrow paths of the second set of narrow paths.

According to the fuse body provided herein, the first set of narrow paths of the first fusing section and the second set of narrow paths of the second fusing section form a differentiated design in the shape of the individual narrow path as well as in the transverse spacing between the narrow paths, wherein in the first set of narrow paths, each narrow path is configured as rectangles of essentially constant cross-section with small lateral spacing between adjacent narrow paths, while in the second set of narrow paths, each narrow path is configured as waist-shaped which cross-section gets smaller as it proximate to the center, and the lateral spacing between adjacent narrow paths is larger. This differentiated design allows the first set of narrow paths to collect heat more easily compared to the second set of narrow paths, resulting in a difference in thermal conductivity and heat dissipation coefficients between the two sets of narrow paths, so as to meet the requirements for 1.1 In overload tolerance as well as 2 In, 3 In, and 5 In overload and short-circuit protection. With the differentiated design of narrow paths, the fuse body can be fabricated from low-cost conductor materials such as copper. In this case, the product still has capacity of high disconnecting and of wide range of overcurrent protection, but also to meet the harsh environmental loads and current inrush application conditions.

In some embodiments, the area of the cross-section of each narrow path of the first set of narrow paths is identical with each other.

In some embodiments, the area of the minimum cross-section of each narrow path of the second set of narrow paths is identical with each other.

In some embodiments, an area of a cross-section of any narrow path of the first set of narrow paths is equal to an area of a minimum cross-section of any narrow path of the second set of narrow paths.

In some embodiments, the first set of through holes comprises a plurality of first through holes arranged in the main body along the transverse direction, wherein the first set of narrow paths comprises narrow paths formed between two adjacent first through holes.

In some embodiments, the first set of through holes further comprises a plurality of second through holes arranged on opposite sides of the plurality of first through holes along the transverse direction, wherein the plurality of second through holes have a transverse dimension larger than the transverse dimension of the plurality of first through holes, and wherein the first set of narrow paths further comprises narrow paths formed between adjacent first through hole and second through hole.

In some embodiments, at least a portion of a side edge of the first through hole adjacent to another first through hole or adjacent to a second through hole is configured as a straight edge, and at least a portion of a side edge of the second through hole adjacent to the first through hole is configured as a straight edge.

In some embodiments, the second set of through holes comprises a plurality of third through holes arranged in the main body along the transverse direction, wherein the third through hole has a transverse dimension greater than the transverse dimension of the first through hole, wherein the second set of narrow paths comprises narrow paths formed between two adjacent third through holes.

In some embodiments, a side edge of the third through hole adjacent to another third through hole is configured as a rounded edge protruding toward the another third through hole.

According to another aspect of this disclosure, there is provided a fuse comprises: a housing; two terminals arranged at opposite ends of the housing; a fuse body connected between the two terminals within the housing, wherein the fuse body is the aforementioned fuse body; and an arc extinguishing medium filled in the housing.

One part of the other features and advantages of this disclosure will be apparent to those skilled in the art upon reading this application, and another part will be described in the specific embodiments below in conjunction with the accompanying drawings.

### BRIEF DESCRIPTION OF THE DRAWINGS

Hereinafter, embodiments of this disclosure are described in detail in connection with the accompanying drawings, wherein:

FIG. 1 is a cross-sectional view of a fuse according to an embodiment of this disclosure;

FIG. 2 is a schematic view of a fuse according to an embodiment of this disclosure.

Reference Number: 1—fuse; 2—housing; 3—liner; 4—terminal; 5—fuse body; 6—main body; 7—first fusing section; 71—first through hole; 72—second through hole; 73—first narrow path; 8—second fusing section; 81—third through hole; 83—second narrow path; L—longitudinal direction; W—transverse direction

### EMBODIMENT

A schematic embodiment of the fuse body for fuse and fuse disclosed in this disclosure is now described in detail with reference to the accompanying drawings. Although the accompanying drawings are provided to present some embodiments of this disclosure, the accompanying drawings do not have to be drawn to the dimensions of the specific embodiments, and certain features may be enlarged, removed, or sectioned locally to better illustrate and explain this disclosure. Some of the components in the accompanying drawings may be adjusted in position according to actual needs without affecting the technical effect. The phrase “in the accompanying drawings” or similar terms appearing in the specification need not refer to all the accompanying drawings or examples.

Certain directional terms used hereinafter to describe the accompanying drawings, such as “inside”, “outside”, “above”, “below”, and other directional terms will be understood to have their normal meanings and to refer to those directions involved in normal viewing of the accompanying drawings. Unless otherwise indicated, the directional terms described herein are substantially in accordance with conventional directions as understood by those skilled in the art.

The terms “first”, “the first”, “second”, “the second” and the like as used in this disclosure do not denote any order, number, or importance, but are used to distinguish one component from others.

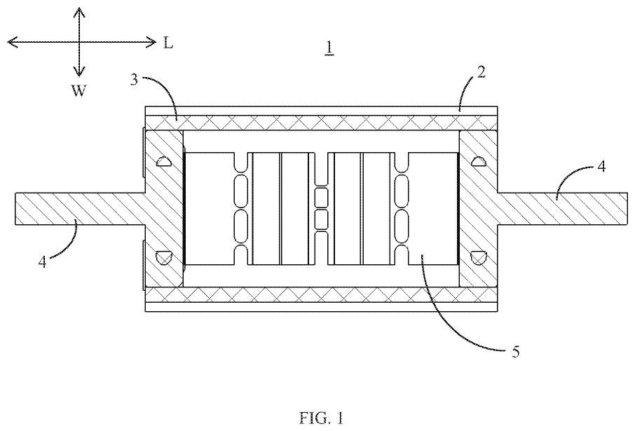

FIG. 1 illustrates a fuse according to an embodiment of this disclosure. As shown, the fuse 1 comprises a housing 2, a terminal 4 and a fuse body 5. The housing 2 may be cylindrical or any other suitable shape, and internally defines an accommodating cavity running along a longitudinal direction L. In one embodiment, the housing 2 is a one-piece member made by a one-piece molding process. In another embodiment, the housing 2 comprises two half-shells assembled together, wherein the two half-shells can be combined together by welding. Two terminals 4 are located at two opposite ends of the accommodating cavity. A liner 3, for example for sealing, may be sandwiched between the outer periphery of the terminals 4 and the inner periphery of the housing 2. The liner 3 may extend along the entire longitudinal length of the housing 2. The fuse body 5 is connected between the two terminals 4 within the accommodating cavity of the housing 2, and the accommodating cavity of the housing 2 is filled with an arc extinguishing medium, for example quartz sand, encapsulating the fuse body 5. The fuse body 5 and the two terminals 4 can each be made by a one-piece molding process and connected together by welding or other suitable electrical connection. Alternatively, the fuse body 5 and the two terminals may be parts of a monolithic piece molded in one piece. The fuse body 5 may be made of a suitable conductor material, such as copper, zinc, silver, etc., wherein copper is preferred. The fuse body 5 is described in detail below as an example where the fuse body 5 is made of a copper material.

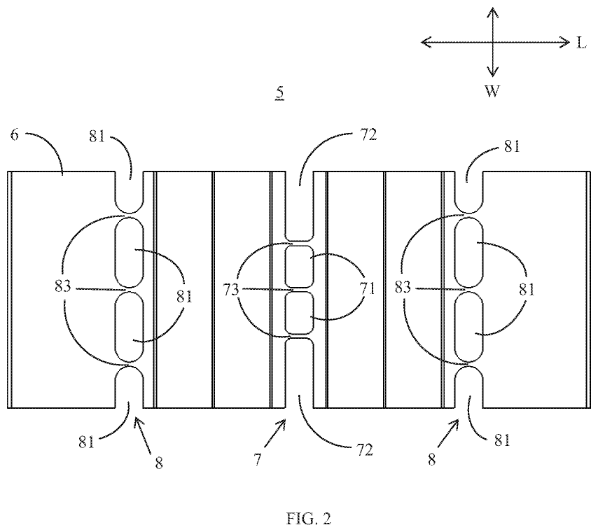

FIG. 2 illustrates a plan view of a fuse body according to an embodiment of this disclosure. As shown, the fuse body 5 is in the form of a sheet having a longitudinal direction L along the length direction and a transverse direction W along the width direction, and having a thickness direction perpendicular to the length direction and the width direction (not shown in the figure). The main body 6 of the fuse body 5 is made of a copper material with differentially designed first fusing section 7 and second fusing section 8 formed thereon.

The first fusing section 7 is located, for example, at a substantially intermediate position of the main body 6 along the longitudinal direction L, and a first set of through holes arranged along the transverse direction W are formed in the main body 6. As shown in FIG. 2, the first set of through holes comprise two first through holes 71 arranged on the main body 6 along the transverse direction W and two second through holes 72 located on opposite sides of the two first through holes 71 along the transverse direction W. Both the first through holes 71 and the second through holes 72 run through the whole of the main body 6 in the thickness direction. A dimension along the lateral direction W of the first through hole 71 is smaller than a dimension along the lateral direction W of the second through hole 72. In the illustrated embodiment, each of the two second through holes 72 extends to a corresponding lateral edge of the main body 6. Narrow paths 73 are formed between two adjacent first through holes 71 and between adjacent first through hole 71 and second through hole 72, these narrow paths 73 are arranged along the orientation of the first set of through holes and form a first set of narrow paths. For the sake of distinction, these narrow paths 73 forming the first set of narrow paths are also referred to herein as the first narrow paths 73.

The first narrow paths 73 are substantially rectangular and its area S1 in cross-section is substantially constant in the longitudinal direction L. In the illustrated embodiment, the first through hole 71 and the second through hole 72 are each chamfered rectangular, but it will be understood that the effect of the chamfered portion on the cross-section area of the first narrow path 73 is negligible for the intended purpose of this disclosure. In an embodiment not shown, the first through hole and the second through hole could be rectangles with straight sides. In another embodiment not shown, the side edges of the first through hole adjacent to another first through hole and the side edges adjacent to the second through hole are straight edges, and the side edges of the second through hole adjacent to the first through hole are straight edges, whereby it is also possible to form a rectangular first narrow path with a substantially constant cross-section between the two adjacent first through holes and between the adjacent first through hole and the second through hole. In this case, the other two side edges of the first through hole and the other two side edges of the second through hole are not limited to be straight edges, but other shapes, such as curved edges.

In the first set of narrow paths, the area S1 of the cross-section of all first narrow paths 73 is identical with each other. In this way, the first narrow paths 73 included in the first set of narrow paths ensure consistent arc initiation time and arc ignition time under high current (e.g., 5 In-20 KA disconnecting current) conditions. As used herein, the “arc initiation time” is the time period from the current exceeding the rated value of the fuse to the generation of an arc inside the fuse in the event of an overload or short circuit in the circuit. The shorter this time period, the fuse will be able to quickly cut off the power supply, thereby protecting electrical equipment and personal safety. “Arc ignition time” refers to the time period from generation of the arc to the time when the arc is extinguished.

The second fusing section 8 is arranged on the main body 6 spaced apart from the first fusing section 7 along the longitudinal direction L, and a second set of through holes arranged along the transverse direction W are formed in the main body 6. As shown, the second set of through holes includes four third through holes 81 arranged on the main body 6 along the transverse direction W. Each of the third through holes 81 passes through the entire main body 6 in the thickness direction. The third through holes 81 have a dimension along the transverse direction W that is larger than the dimension of the first through holes 71 along the transverse direction W. In the illustrated embodiment, each of two third through apertures 81 located on the lateral outermost side each extend to a corresponding side edge of the main body 6. Between the two adjacent third through holes 81, the narrow paths 83 are formed and these narrow paths 83 are arranged along the orientation of the second set of through holes and form a second set of narrow paths. For the sake of distinction, these narrow paths 83 forming the second set of narrow paths 83 are also referred to herein as second narrow paths 83.

The second narrow path 83 is in a waisted shape narrowing in the middle, and in the longitudinal direction L, the area of the cross-section of the second narrow path 83 is tapering along a direction from the ends towards the center, and a minimum cross-section of area S2 at the longitudinal center of the second narrow path 83 is formed. In the illustrated embodiment, the side edges of the third through hole 81 adjacent another third through hole 81 are curved edges protruding towards the another third through hole 81, thereby a waist shaped second narrow path 83 is formed between the two adjacent third through holes 81, while the remaining two edges of the third through hole 81 are straight edges. In an embodiment not shown, in addition to the side edge of the third through hole adjacent to another third through hole being a curved edge protruding towards the another third through hole, the remaining two edges of the third through hole could also be curved edges, whereby, for example, the third through hole may be constructed in the shape of a circle, an oval, or the like.

In the second set of narrow paths, the area S2 of the minimum cross-section of all second narrow paths 83 is the same. In this way, the second narrow paths 83 included in the second set of narrow paths can ensure consistency in the arc initiation time and the arc ignition time under high current conditions (e.g., a disconnecting current of 5 In-20 KA).

Since the dimension of the first through hole 71 along the transverse direction W is smaller than the dimension of the third through hole 81 along the transverse direction W, the transverse spacing between two adjacent first narrow paths 73 in the first set of narrow paths is smaller than the transverse spacing between two adjacent second narrow paths 83 in the second set of narrow paths. By this, the first set of narrow paths is designed to be differentiated from the second set of narrow paths in terms of the shape of the individual narrow path and the transverse spacing between two narrow paths. This differentiated design results in easier heat collection in the first set of narrow paths compared to the second set of narrow paths, which results in a difference in thermal conductivity and heat dissipation coefficient between the first set of narrow paths and the second set of narrow paths. This differentiated design also facilitates meeting the fusing characteristics up to 2 In. Under the same overcurrent condition, the first set of narrow paths will be broken earlier than the second set of narrow paths. Based on the different overcurrent, the difference in broken time between the first and second set of narrow paths will be different, e.g. <100 ms at 20 KA.

The size relationship between S1 and S2 can be designed according to the desired product characteristics while ensuring that all first narrow paths 73 contained in the first set of narrow paths have the same area S1 in cross-section and all second narrow paths 83 contained in the second set of narrow paths have the same area S2 in minimum cross-section. In one embodiment, S1=S2.

As shown in FIGS. 1 and 2, two second fusing sections 8 are arranged on opposite sides of the first fusing section 7 along the longitudinal direction L. However, it will be understood that the number of first fusing sections 7 and second fusing sections 8 can be designed according to the desired product features, for example only one first fusing section 7 as well as one second fusing section 8 can be arranged on the main body 6.

Furthermore, although the first fusing section 7 is shown to include two first through holes 71 and two second through holes 72, and the second fusing section 8 includes four third through holes 81, it is understood that the number and size of the first through holes 71, the second through holes 72, and the third through holes 81 could be adjusted, as long as to configure a substantially balanced cross-section of the first narrow path in the first set of narrow paths and configure a cross-section of the second narrow path in the second set of narrow paths tapering in a direction toward the center, and the transverse spacing between the two adjacent first narrow paths is less than the transverse spacing between the two adjacent second narrow paths, in order to satisfy the requirements for a differentiated design of the first and the second set of narrow paths.

For example, in an embodiment not shown, the first set of through holes of the first fusing section comprises a plurality of first through holes of the same transverse dimension (i.e., omitting the second through hole), and a first narrow path of a rectangular shape with a substantially constant cross-section is formed between two adjacent first through holes, while the second fusing section comprises a plurality of third through holes of the same transverse dimension, and a second narrow path of a waisted shape with a cross-section tapering in a direction toward the center is formed between two adjacent third through holes. The transverse dimension of the third through hole is larger than the transverse dimension of the first through hole, thereby the transverse spacing between two adjacent first narrow paths in the first set of narrow paths is smaller than the transverse spacing between two adjacent second narrow paths in the second set of narrow paths. In this way, the first set of narrow paths is differentiated from the second set of narrow paths in terms of the shape of the individual narrow path and the transverse spacing between the narrow paths, in the sense of the present application.

It should be understood that, although this specification is described in accordance with various embodiments, not each embodiment contains only one independent technical solution, this description of the specification is only for the sake of clarity, and the person skilled in the art should take the specification as a whole, and the technical solutions in the various embodiments can be combined appropriately to form other embodiments that can be understood by the person skilled in the art.

The foregoing is only a schematic and specific implementation of this disclosure, and is not intended to limit the scope of this disclosure. Any equivalent changes, modifications and combinations made by any person skilled in the art without departing from the ideas and principles of this disclosure shall fall within the scope of protection of this disclosure.

1. A fuse body for a fuse having a longitudinal direction (L) along a length direction and a transverse direction (W) along a width direction, wherein the fuse body comprises:
a main body (6);
a first fusing section (7) comprising a first set of through holes arranged in the main body (6) along the transverse direction (W) and a first set of narrow paths formed in the main body (6) along the orientation of the first set of through holes, wherein in the longitudinal direction (L), the area of the cross-section of each narrow path of the first set of narrow paths is constant;
a second fusing section (8) spaced apart from the first fusing section (7) in the longitudinal direction (L), wherein the second fusing section (8) comprises a second set of through holes disposed in the main body (6) along the transverse direction (W) and a second set of narrow paths formed in the main body (6) along the orientation of the second set of through holes, wherein in the longitudinal direction (L), the area of the cross-sectional of each narrow path of the second set of narrow paths tapers in a direction toward the center of this narrow path;
wherein a transverse spacing between two adjacent narrow paths of the first set of narrow paths is less than a transverse spacing between two adjacent narrow paths of the second set of narrow paths.

2. The fuse body for the fuse according to claim 1, wherein the area of the cross-section of each narrow path of the first set of narrow paths is identical with each other.

3. The fuse body for the fuse according to claim 1, wherein the area of the minimum cross-section of each narrow path of the second set of narrow paths is identical with each other.

4. The fuse body for the fuse according to claim 1, wherein an area of a cross-section of any narrow path of the first set of narrow paths is equal to an area of a minimum cross-section of any narrow path of the second set of narrow paths.

5. The fuse body for the fuse according to claim 1, wherein the first set of through holes comprises a plurality of first through holes (71) arranged in the main body (6) along the transverse direction (W), wherein the first set of narrow paths comprises narrow paths formed between two adjacent first through holes (71).

6. The fuse body for the fuse according to claim 5, wherein the first set of through holes further comprises a plurality of second through holes (72) arranged on opposite sides of the plurality of first through holes (71) along the transverse direction (W), wherein the plurality of second through holes (72) have a transverse dimension larger than the transverse dimension of the plurality of first through holes (71), and wherein the first set of narrow paths further comprises narrow paths formed between adjacent first through hole (71) and second through hole (72).

7. The fuse body for the fuse according to claim 6, wherein at least a portion of a side edge of the first through hole (71) adjacent to another first through hole (71) or adjacent to a second through hole (72) is configured as a straight edge, and at least a portion of a side edge of the second through hole (72) adjacent to the first through hole (71) is configured as a straight edge.

8. The fuse body for the fuse according to claim 5, wherein the second set of through holes comprises a plurality of third through holes (81) arranged in the main body (6) along the transverse direction (W), wherein the third through hole (81) has a transverse dimension greater than the transverse dimension of the first through hole (71), wherein the second set of narrow paths comprises narrow paths formed between two adjacent third through holes (81).

9. The fuse body for the fuse according to claim 8, wherein a side edge of the third through hole (81) adjacent to another third through hole (81) is configured as a rounded edge protruding toward the another third through hole (81).

10. A fuse comprises:
a housing (2);
two terminals (4) arranged at opposite ends of the housing (2);
a fuse body (5) connected between the two terminals (4) within the housing (2), wherein the fuse body (5) is the fuse body as defined in claim 1; and
an arc extinguishing medium filled in the housing (2).
